(19) United States
(12) Patent Application Publication
(10) Pub. No.: US 2025/0041996 A1
(43) Pub. Date: Feb. 6, 2025

(54) GRINDING WHEEL, BACK-GRINDING APPARATUS INCLUDING THE SAME, ABRASIVE ARTICLE MANUFACTURING METHOD

(71) Applicant: SAMSUNG ELECTRONICS CO., LTD., Suwon-si (KR)

(72) Inventors: Wonkeun Cho, Suwon-si (KR); Donghoon Kwon, Suwon-si (KR)

(73) Assignee: SAMSUNG ELECTRONICS CO., LTD., Suwon-si (KR)

(21) Appl. No.: 18/425,770

(22) Filed: Jan. 29, 2024

(30) Foreign Application Priority Data
Aug. 2, 2023 (KR) 10-2023-0101173

(51) Int. Cl. B24D 7/06; B24D 18/00

(52) U.S. Cl. CPC B24D 7/06; B24D 18/009

(57) ABSTRACT

Disclosed are grinding wheels, back-grinding apparatuses, and abrasive article manufacturing methods. The grinding wheel comprises a wheel body having a disk shape and an abrasive article combined with one surface of the wheel body. The abrasive article includes an abrasive body and a plurality of grinding particles in the abrasive body. The abrasive body provides a groove hole that is recessed in a first direction as a horizontal direction on a lateral surface of the abrasive body. A length in the first direction of the groove hole is less than a width in the first direction of the abrasive body.

### CROSS-REFERENCE TO RELATED APPLICATION

This U.S. nonprovisional application claims priority under 35 U.S.C § 119 to Korean Patent Application No. 10-2023-0101173 filed on Aug. 2, 2023, in the Korean Intellectual Property Office, the disclosure of which is hereby incorporated by reference in its entirety.

### BACKGROUND

### 1. Field

The disclosure relates to a grinding wheel, a back-grinding apparatus including the same, and an abrasive article manufacturing method, and more particularly, to a grinding wheel capable of increasing the degree of grinding by using a groove hole to easily detach abrasive article grinding particles, a back-grinding apparatus including the same, and an abrasive article manufacturing method.

### 2. Description of Related Art

A semiconductor device may be fabricated through various processes. A semiconductor process may include a front-end-of-line (FEOL) process and a back-end-of-line (BEOL) process. A back-grinding process may be performed after the FEOL process and before the BEOL process. The back-grinding process may be an operation of thinning rear surfaces of substrates. The back-grinding process may remove contaminants occurring in the FEOL process and may reduce a chip thickness.

The rear surface of the substrate may be ground after performing a tape lamination process in which the substrate is attached with a tape to execute the back-grinding process. After that, before a sawing process to separate the substrate into chips, a wafer mounting process may be performed to place the substrate on a tape.

A grinding wheel may be used to grind the rear surface of the substrate. For example, an abrasive article of the grinding wheel may grind the rear surface of the substrate.

### SUMMARY

One or more embodiments of the present disclosure provide a grinding wheel capable of using a groove hole to achieve an easy detachment of grinding particles, a back-grinding apparatus including the same, and an abrasive article manufacturing method.

One or more embodiments of the present disclosure provide a grinding wheel capable of adjusting the number of grinding particles and a density and shape of groove holes, a back-grinding apparatus including the same, and an abrasive article manufacturing method.

One or more embodiments of the present disclosure provide a grinding wheel capable of simultaneously forming a plurality of groove holes, a back-grinding apparatus including the same, and an abrasive article manufacturing method

One or more embodiments of the present disclosure provide a grinding wheel capable of using a mask to form a groove hole, a back-grinding apparatus including the same, and an abrasive article manufacturing method.

The object of the present disclosure is not limited to the mentioned above, and other objects which have not been mentioned above will be clearly understood to those skilled in the art from the following description.

According to an aspect of the disclosure, a grinding wheel includes: a wheel body; and an abrasive article on one surface of the wheel body, wherein the abrasive article includes: an abrasive body including a first groove hole that is recessed on a lateral surface of the abrasive article in a first direction; and a plurality of grinding particles in the abrasive body, and wherein a length of the first groove hole in the first direction is less than a width of the abrasive body in the first direction.

According to an aspect of the disclosure, a back-grinding apparatus includes: a spindle assembly that is rotatable and is vertically movable in a vertical direction; and a substrate support below the spindle assembly, wherein the spindle assembly includes: a grinding wheel; and a driving unit configured to drive the grinding wheel to move toward the substrate support and away from the substrate support, wherein the grinding wheel includes: a wheel body; and an abrasive article on a bottom surface of the wheel body, wherein the abrasive article includes: an abrasive body including a first groove hole recessed toward the abrasive article from a lateral surface of the abrasive body; and a plurality of grinding particles in the abrasive body, and wherein a length of the first groove hole is less than a width of the abrasive article.

According to an aspect of the disclosure, a method of manufacturing an abrasive article includes: placing an abrasive body on a lateral surface of a punching machine; and forming a groove hole in the abrasive body using the punching machine to form the groove hole on a first surface of the abrasive body, wherein the punching machine includes one of a water jet nozzle and a laser generator, and the punching machine is configured to produce a punching beam, wherein the groove hole extends from the first surface toward a second surface of the abrasive body, wherein the second surface stands opposite to the first surface, and wherein a length of the groove hole is less than a width of the abrasive body.

According to an aspect of the disclosure, a back-grinding apparatus includes: a substrate support; and a spindle assembly that is rotatable and is vertically movable in a vertical direction, the spindle assembly including: a grinding wheel including a wheel body and an abrasive article disposed on a bottom surface of the wheel body; and a driving unit configured to drive the grinding wheel to move toward the substrate support and away from the substrate support, wherein the abrasive article includes: an abrasive body including a first surface and a second surface spaced apart in a first direction from the first surface, a plurality of first groove holes formed from the first surface toward the second surface, the plurality of first groove holes including a first groove hole and a second groove hole adjacent to the first groove hole; and a plurality of second groove holes formed from the second surface toward the first surface, the plurality of second groove holes including a third groove hole and a fourth groove hole adjacent to the third groove hole; and a plurality of grinding particles in the abrasive body, and wherein the first groove hole and the third groove hole are located at a first level of the abrasive body, wherein the second groove hole and the fourth groove hole are located at a second level of the abrasive body, wherein a sum of a length of the first groove hole and a length of the third groove hole is less than a width of the abrasive body in the first direction, and wherein a sum of a length of the second groove hole and a length of the fourth groove hole is less than the width of the abrasive body in the first direction.

Details of other example embodiments are included in the description and drawings.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 illustrates a perspective view showing a back-grinding apparatus according to one or more embodiments of the present disclosure;

FIG. 2 illustrates a front view showing a back-grinding apparatus according to one or more embodiments of the present disclosure;

FIG. 3 illustrates a top perspective view showing a grinding wheel according to one or more embodiments of the present disclosure;

FIG. 4 illustrates a bottom view showing a grinding wheel according to one or more embodiments of the present disclosure;

FIG. 5 illustrates an enlarged front view showing an abrasive article according to one or more embodiments of the present disclosure;

FIG. 6 illustrates a perspective view showing an abrasive article having a groove hole formed therein according to one or more embodiments of the present disclosure;

FIG. 7 illustrates a front view showing an abrasive article having a groove hole formed therein according to one or more embodiments of the present disclosure;

FIG. 8 illustrates a side view showing an abrasive article having a groove hole formed therein according to one or more embodiments of the present disclosure;

FIG. 9 illustrates a perspective view showing an abrasive article having a groove hole formed therein according to one or more embodiments of the present disclosure;

FIG. 10 illustrates a side view showing an abrasive article having a groove hole formed therein according to one or more embodiments of the present disclosure;

FIG. 11 illustrates a perspective view showing an abrasive article having a groove hole formed therein according to one or more embodiments of the present disclosure;

FIG. 12 illustrates a side view showing an abrasive article having a groove hole formed therein according to one or more embodiments of the present disclosure;

FIG. 13 illustrates a side view showing an abrasive article having a groove hole formed therein according to one or more embodiments of the present disclosure;

FIG. 14 illustrates a perspective view showing an abrasive article having a groove hole formed therein according to one or more embodiments of the present disclosure;

FIG. 15 illustrates a perspective view showing an abrasive article having a groove hole formed therein according to one or more embodiments of the present disclosure;

FIG. 16 illustrates a flow chart showing an abrasive article manufacturing method according to one or more embodiments of the present disclosure;

FIG. 17 illustrates a perspective view showing an abrasive article manufacturing method according to the flow chart of FIG. 16;

FIG. 18 illustrates a perspective view showing an abrasive article manufacturing method according to the flow chart of FIG. 16;

FIG. 19 illustrates a perspective view showing an abrasive article manufacturing method according to the flow chart of FIG. 16; and

FIG. 20 illustrates a perspective view showing an abrasive article manufacturing method according to the flow chart of FIG. 16.

### DETAILED DESCRIPTION

The following will now describe one or more embodiments of the present disclosure with reference to the accompanying drawings. Like reference numerals may indicate like components throughout the description.

As used herein, a plurality of “units”, “modules”, “members”, and “blocks” may be implemented as a single component or a single “unit”, “module”, “member”, and “block” may include a plurality of components.

Also, when a part “includes” or “comprises” an element, unless there is a particular description contrary thereto, the part may further include other elements, not excluding the other elements.

Throughout the description, when a member is “on” another member, this includes not only when the member is in contact with the other member, but also when there is another member between the two members.

Herein, the expression “at least one of a, b or c” indicates “only a,” “only b,” “only c,” “both a and b,” “both a and c,” “both b and c,” or “all of a, b, and c.”

It will be understood that, although the terms first, second, third, etc., may be used herein to describe various elements, is the disclosure should not be limited by these terms. These terms are only used to distinguish one element from another element.

As used herein, the singular forms “a,” “an” and “the” are intended to include the plural forms as well, unless the context clearly indicates otherwise.

In this description, symbol D1 may indicate a first direction, symbol D2 may indicate a second direction that intersects the first direction D1, and symbol D3 may indicate a third direction that intersects each of the first direction D1 and the second direction D2.

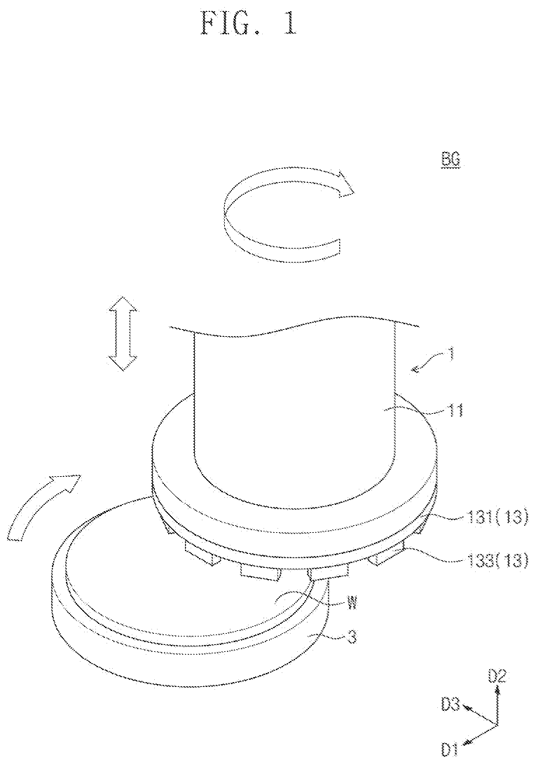

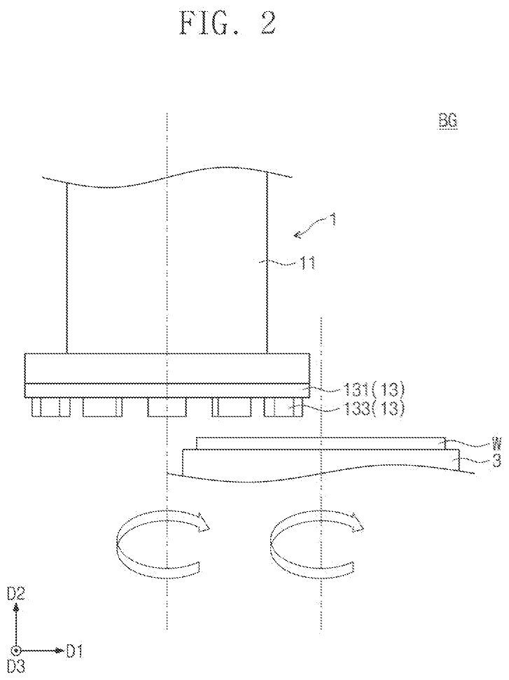

FIG. 1 illustrates a perspective view showing a back-grinding apparatus BG according to one or more embodiments of the present disclosure. FIG. 2 illustrates a front view showing the back-grinding apparatus BG according to one or more embodiments of the present disclosure.

Referring to FIGS. 1 and 2, the back-grinding apparatus BG may be provided. The back-grinding apparatus BG may include a spindle assembly 1 and a chuck table 3.

The spindle assembly 1 may include a driving unit 11 and a grinding wheel 13. The driving unit 11 may be combined with an upper portion of the grinding wheel 13. For example, the driving unit 11 may be combined with the grinding wheel 13 through a bolt, an electromagnet, and/or a magnet, while being positioned on the upper portion of the grinding wheel 13. However, the combination between the driving unit 11 and the grinding wheel 13 is not limited thereto, and may include any other suitable ways in which the driving unit 11 can drive the grinding wheel 13 to rotate and move. The driving unit 11 may control a rotation speed of the grinding wheel 13. The driving unit 11 may drive the grinding wheel 13 to move upwardly and downwardly so that a lower portion of the grinding wheel 13 may contact a substrate W. In this description, the term “substrate” may mean a silicon (Si) wafer, but the present disclosure is not limited thereto.

The grinding wheel 13 may be upwardly and downwardly movable and rotatable driven by the driving unit 11. The grinding wheel 13 will be discussed below.

The chuck table 3 may serve as a substrate support to support the substrate W. The chuck table 3 may have a disk shape whose size is greater than that of the substrate W so as to place the substrate W on the chuck table 3. A vacuum line may be separately connected to an inner side of the chuck table 3, thereby vacuum-securing the substrate W. The chuck table 3 may rotate. The chuck table 3 may be equipped on its lower portion with a rotating unit that drives the chuck table 3 to rotate at a constant speed.

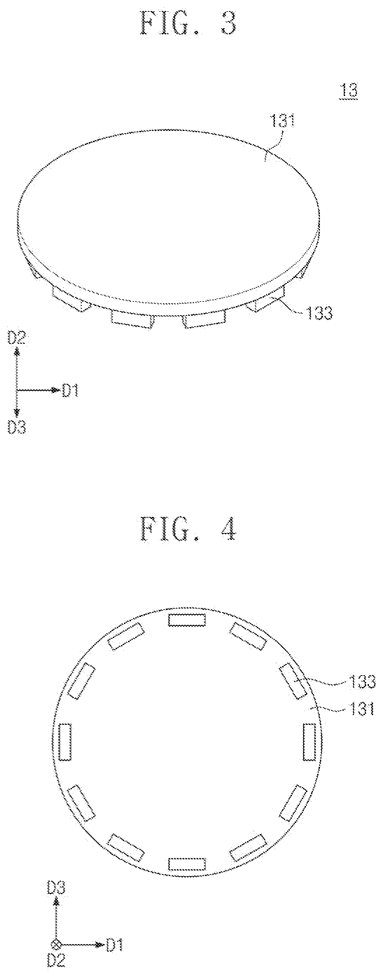

FIG. 3 illustrates a perspective view showing the grinding wheel 13 according to one or more embodiments of the present disclosure. FIG. 4 illustrates a bottom view showing the grinding wheel 13 according to one or more embodiments of the present disclosure.

The grinding wheel 13 may include a wheel body 131 and an abrasive article 133. The wheel body 131 may have, for example a plate shape. The wheel body 131 may have a circular shape. For example, the wheel body 131 may have a disk shape. The present disclosure, however, is not limited thereto, and the wheel body 131 may have any other suitable shapes. The wheel body 131 may support the abrasive article 133. For example, a plurality of abrasive articles 133 may be coupled to one surface of the wheel body 131. On one surface of the wheel body 131, the plurality of abrasive articles 133 may be disposed spaced apart from each other in a circumferential direction of the wheel body 131. A single abrasive article 133 will be described below in the interest of convenience. The abrasive article 133 may grind the substrate W, while being rotated by the driving unit 11. The abrasive article 133 may be provided in the form of an individual segment. As the abrasive article 133 is formed as a segment, the abrasive article 133 may be prevented from being distorted due to friction-induced thermal expansion during grinding. The abrasive article 133 will be further discussed in detail below.

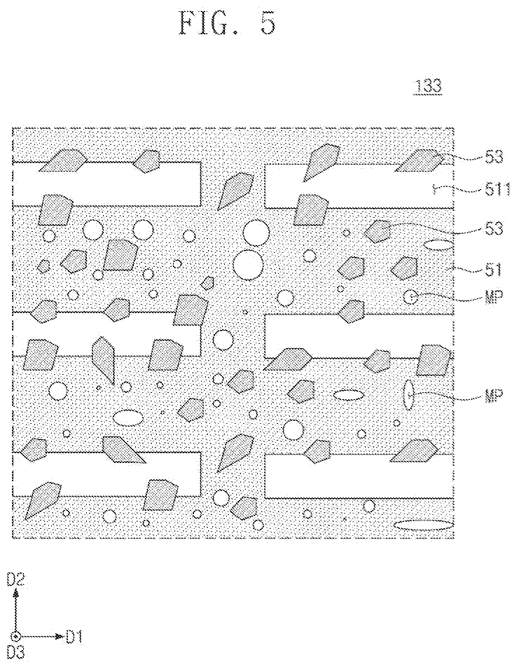

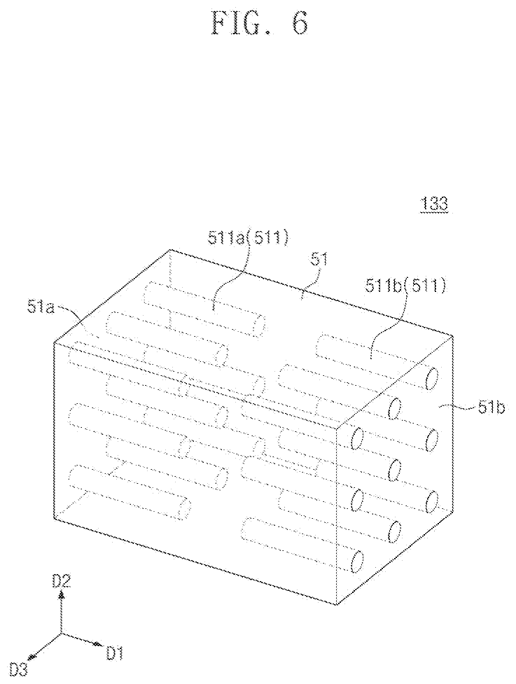

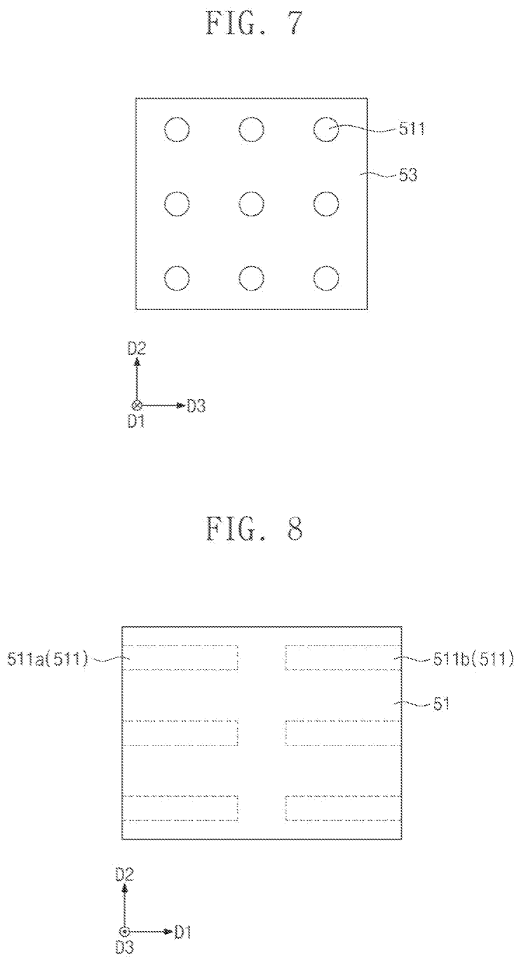

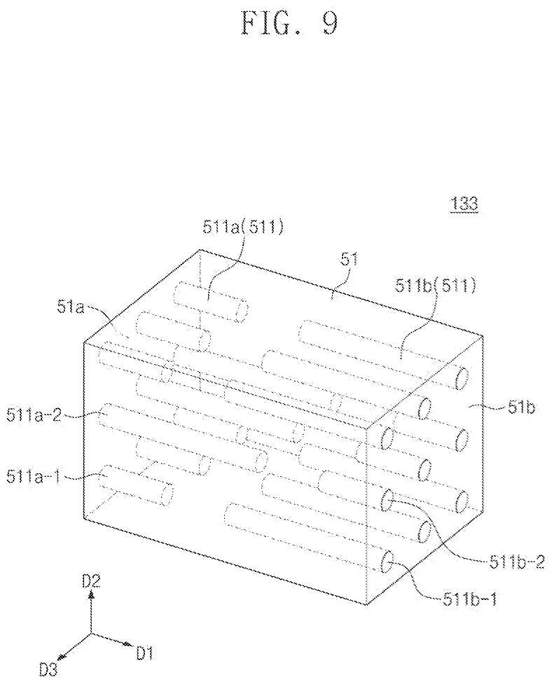

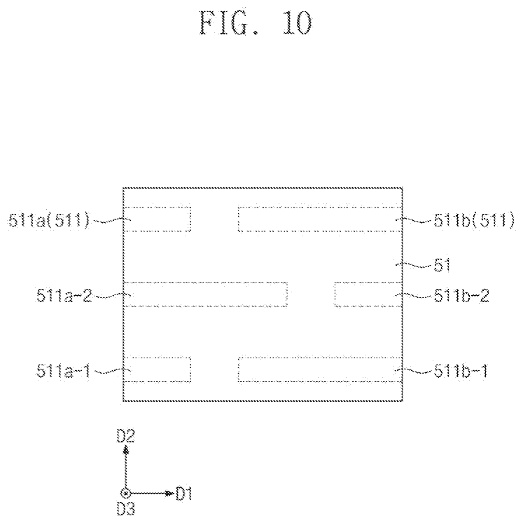

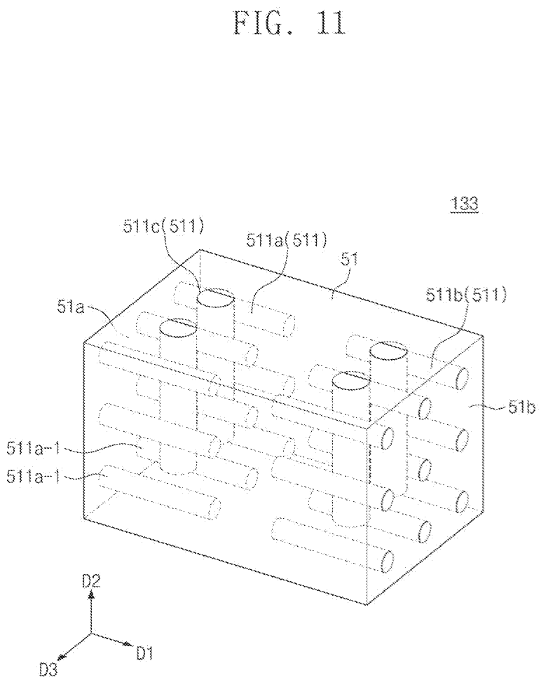

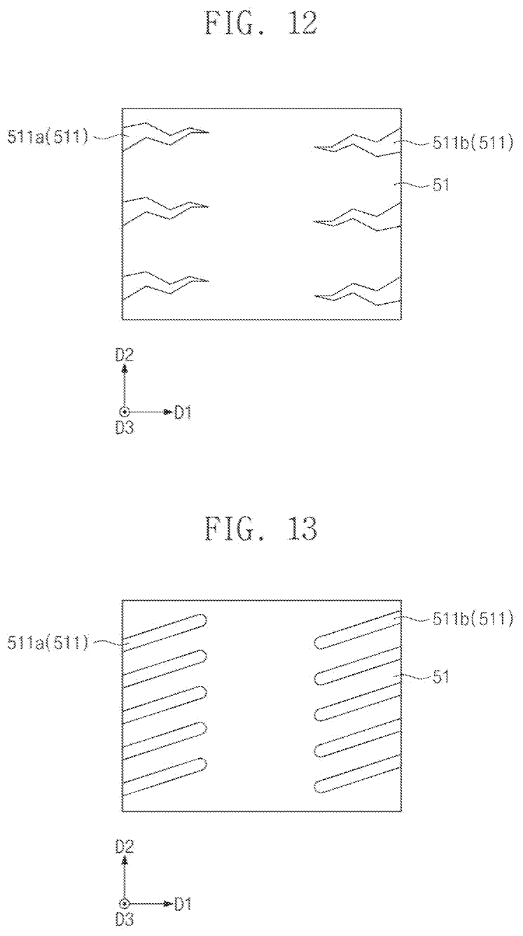

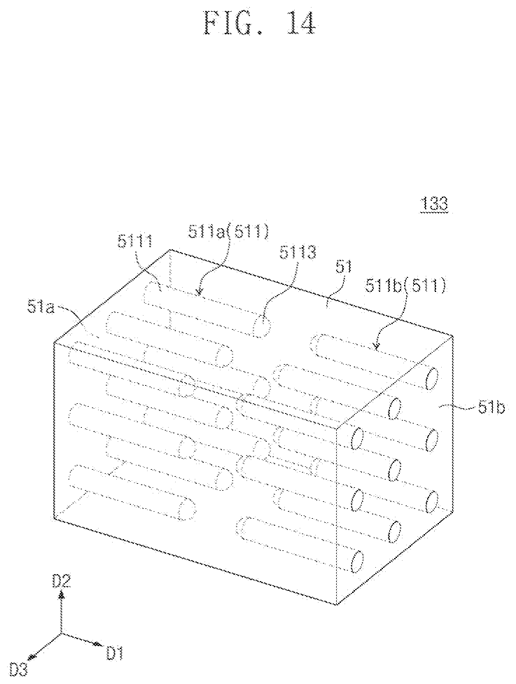

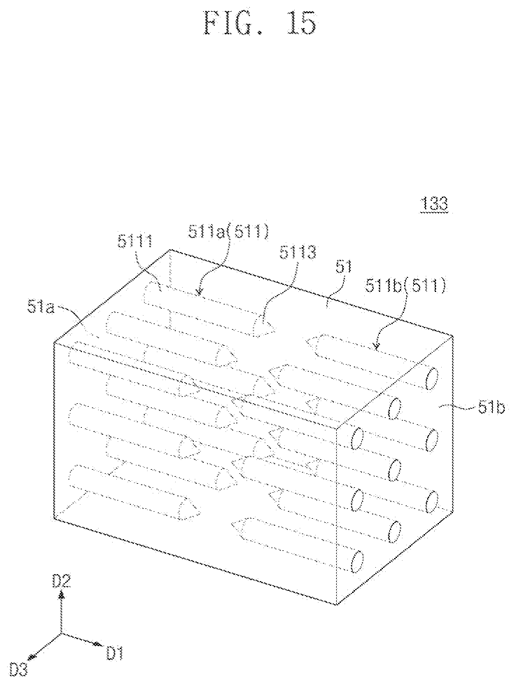

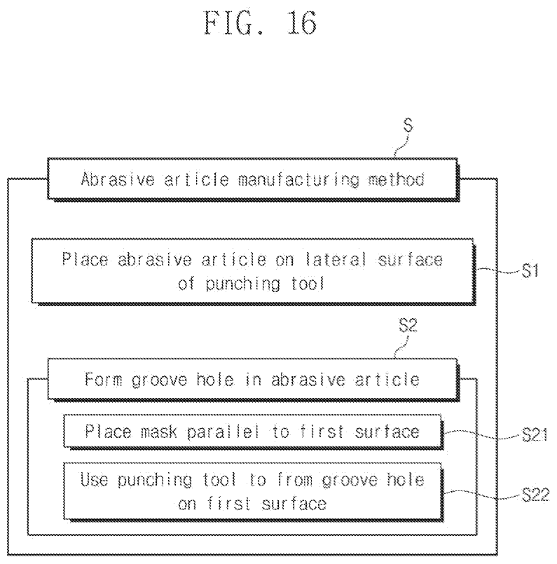

FIG. 5 illustrates an enlarged front view showing the abrasive article 133 according to one or more embodiments of the present disclosure. FIG. 6 illustrates a perspective view showing the abrasive article 133 having a groove holes 511 formed therein according to one or more embodiments of the present disclosure. FIG. 7 illustrates a front view showing the abrasive article 133 having the groove holes 511 formed therein according to one or more embodiments of the present disclosure. FIG. 8 illustrates a side view showing the abrasive article 133 having the groove holes 511 formed therein according to one or more embodiments of the present disclosure. FIG. 9 illustrates a perspective view showing the abrasive article 133 having the groove holes 511 formed therein according to one or more embodiments of the present disclosure. FIG. 10 illustrates a side view showing the abrasive article 133 having the groove holes 511 formed therein according to one or more embodiments of the present disclosure. FIG. 11 illustrates a perspective view showing the abrasive article 133 having the groove holes 511 formed therein according to one or more embodiments of the present disclosure. FIG. 12 illustrates a side view showing the abrasive article 133 having the groove holes 511 formed therein according to one or more embodiments of the present disclosure. FIG. 13 illustrates a side view showing the abrasive article 133 having the groove holes 511 formed therein according to one or more embodiments of the present disclosure. FIG. 14 illustrates a perspective view showing the abrasive article 133 having the groove holes 511 formed therein according to one or more embodiments of the present disclosure. FIG. 15 illustrates a perspective view showing the abrasive article 133 having the groove holes 511 formed therein according to one or more embodiments of the present disclosure.

Referring to FIG. 5, the abrasive article 133 may include an abrasive body 51 and a grinding particle 53. The abrasive body 51 may have a rectangular hexahedral shape as illustrated in FIG. 3. The present disclosure, however, is not limited thereto, and the abrasive body 51 may have any other suitable shapes. The abrasive body 51 may provide therein a micro-pore MP and the groove hole 511. The micro-pore MP may have a circular or oval shape. The grinding particle 53 may include diamond to grind the substrate W. The grinding particle 53 may have various shapes. The grinding particle 53 may have an irregular polygonal shape. A plurality of grinding particles 53 may be provided in one abrasive article 133. The plurality of grinding particles 53 may be randomly disposed in the abrasive body 51. For convenience, one grinding particle 53 will be discussed in this disclosure. The grinding particle 53 may be positioned in the abrasive article 133. A portion of the grinding particle 53 may be outwardly exposed through the groove hole 511. The groove hole 511 will be further discussed in detail below.

Referring to FIGS. 6, 7 and 8, there may be provided the abrasive article 133 having the groove hole 511 formed therein. The grinding particle 53 and the micro-pore MP in the abrasive article 133 are omitted from FIGS. 6, 7 and 8 for clearness of the drawings and convenience of description. For example, only groove hole 511 is be shown in the abrasive body 51. A lateral surface of the abrasive article 133 may include a first surface 51a and a second surface 51b that is spaced apart in the first direction D1 from the first surface 51a. The second surface 51b may stand opposite to the first surface 51a. The abrasive body 51 may provide the groove hole 511 formed recessed in the first direction D1 as a horizontal direction on a lateral surface of the abrasive body 51. The groove hole 511 may be formed recessed from the lateral surface of the abrasive body 51 toward an inside of the abrasive article 133. A length in the first direction D1 of the groove hole 511 may be less than a width in the first direction D1 of the abrasive body 51. The groove holes 511 may be formed at a regular interval on an outer surface of the abrasive article 133. The present disclosure, however, is not limited thereto, and the groove holes 511 may be formed at different intervals. The groove hole 511 may include a first groove hole 511a that is formed from a first surface 51a toward a second surface 51b. The groove hole 511 may include a second groove hole 511b that is formed from the second surface 51b toward the first surface 51a. The first groove hole 511a and the second groove hole 511b may be located at the same level (i.e., plane) of abrasive article 133. The present disclosure, however, is not limited thereto, and the first groove hole 511a and the second groove hole 511b may be located at different levels. A sum of lengths of the first groove hole 511a and the second groove hole 511b may be less than a width of the abrasive article 133. When the first groove hole 511a and the second groove hole 511b are located at different levels, a sum of lengths of the first groove hole 511a and the second groove hole 511b may be greater than a width of the abrasive article 133. A length of the first groove hole 511a may be the same as that of the second groove hole 511b. The present disclosure, however, is not limited thereto.

Referring to FIGS. 9 and 10, the first groove hole 511a may include a 1-1^{st} groove hole 511a-1 and a 1-2^{nd} groove hole 511b-2 positioned on the 1-1^{st} groove hole 511a-1. The second groove hole 511b may include a 2-1^{st} groove hole 511b-1 located at the same level as that of the 1-1^{st} groove hole 511a-1. The second groove hole 511b may include a 2-2^{nd} groove hole 511b-2 positioned on the 2-1^{st} groove hole 511b-1. The 2-2^{nd} groove hole 511b-2 may be located at the same level as that of the 1-2^{nd} groove hole 511b-2. A length of the 1-1^{st} groove hole 511a-1 may be less than that of the 2-1^{st} groove hole 511b-1. A length of the 1-2^{nd} groove hole 511a-2 may be greater than that of 2-2^{nd} groove hole 511b-2. The length and position of the groove hole 511 are not limited thereto. A plurality of groove holes 511 may all have different lengths. The position, number, density, and length of the groove hole 511 may be changed based on an abrasive article manufacturing method S (see FIG. 16).

Referring to FIG. 11, the first groove hole 511a may include a plurality of 1-1^{st} groove holes 511a-1 located at the same level. The abrasive body 51 may further provide a third groove hole 511c between a plurality of 1-1^{st} groove holes 511a-1, which third groove hole 511c may be formed recessed in direction opposite to the second direction D2 perpendicular to the first direction D1. A central axis of the third groove hole 511c may not intersect central axes of the plurality of 1-1^{st} groove holes 511a-1. The third groove hole 511c may be formed recessed in a vertical downward direction from a top surface of the abrasive body 51. The present disclosure, however, is not limited thereto. The third groove hole 511c may be provided in the abrasive body 51 lest the third groove hole 511c intersect the first groove hole 511a and the second groove hole 511b. A length in the second direction D2 of the third groove hole 511c may be less than a height of the abrasive article 133.

Referring to FIGS. 12 and 13, the groove hole 511 may have various shapes. As shown in FIG. 12, the groove hole 511 may extend in a zigzag direction. As shown in FIG. 13, an extending direction of the groove hole 511 may include the first direction D1 and the second direction D2. For example, the groove hole 511 may extend obliquely to the first direction D1.

Referring to FIGS. 14 and 15, each of a plurality of groove holes 511 may include a groove body 5111 connected to the lateral surface of the abrasive article 133 and a groove head 5113 connected to an end of the groove body 5111. The groove body 5111 may have one of a conical shape, a cylindrical shape, and a square pillar shape. The present disclosure, however, is not limited thereto, and the groove body 5111 may have a shape that is changed in accordance with the formation of the groove hole 511. As shown in FIGS. 14 and 15, the groove head 5113 may have one of a hemispherical shape and a conical shape. The present disclosure, however, is not limited thereto.

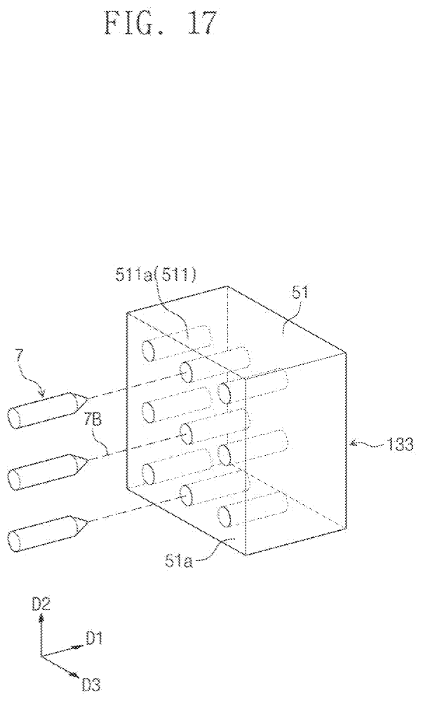

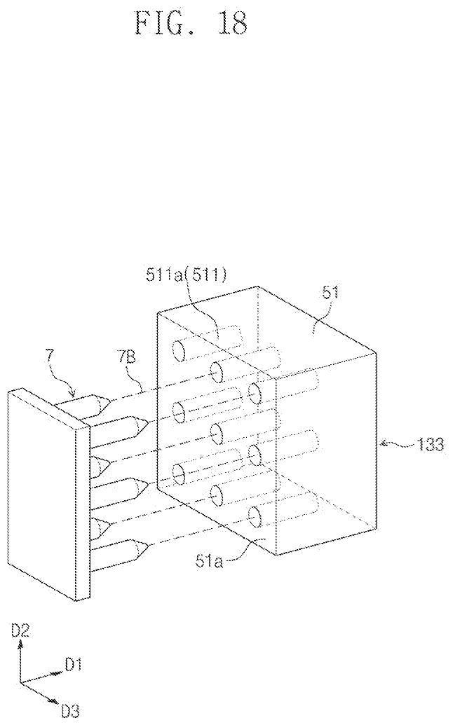

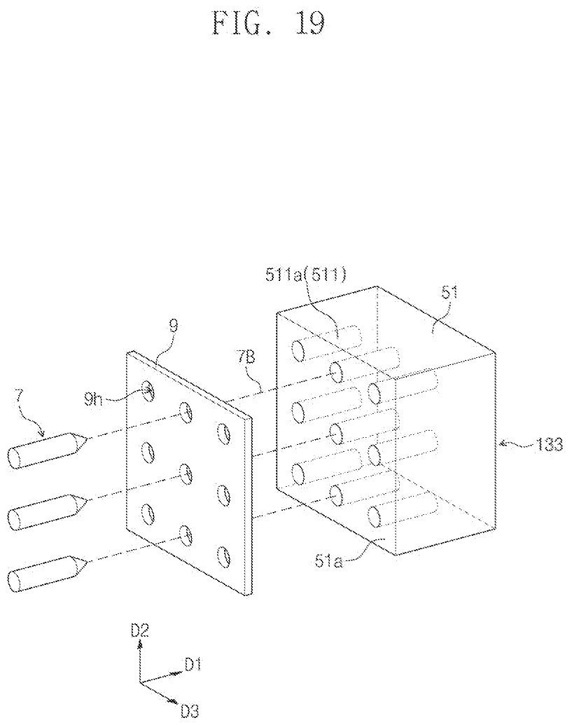

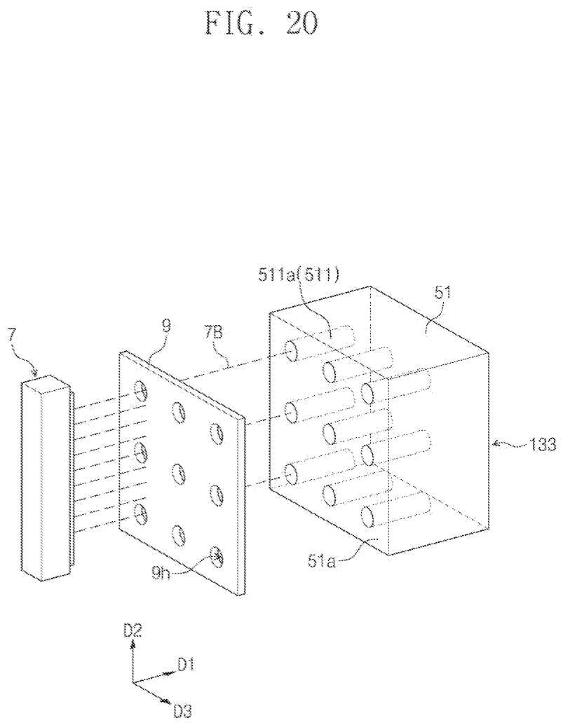

FIG. 16 illustrates a flow chart showing an abrasive article manufacturing method S according to one or more embodiments of the present disclosure. FIG. 17 illustrates a perspective view showing the abrasive article manufacturing method S according to the flow chart. FIG. 18 illustrates a perspective view showing the abrasive article manufacturing method S according to the flow chart. FIG. 19 a perspective view showing the abrasive article manufacturing method S according to the flow chart. FIG. 20 illustrates a perspective view showing the abrasive article manufacturing method S according to the flow chart.

Referring to FIG. 16, the abrasive article manufacturing method S may include placing the abrasive article 133 on a lateral surface of a punching machine 7 (S1) and forming the groove hole 511 in the abrasive article 133 (S2). The groove hole formation operation S2 may include placing a mask 9 parallel to the first surface 51a (S21) and using the punching machine 7 to form the groove hole 511 on the first surface 51a (S22). For convenience of description in this disclosure, it may be assumed that the punching machine 7 is used to form the groove hole 511 recessed from the first surface 51a toward an inside of the abrasive body 51.

Referring to FIGS. 17 and 18, the punching machine 7 may be provided. The punching machine 7 may include one of a water jet nozzle and a laser generator producing a punching beam 7B. The punching beam 7B may include a laser beam or a water jet. The present disclosure, however, is not limited thereto, and any other suitable component may be included which can form the groove hole 511 in the abrasive body 51. The laser generator may irradiate a laser beam to form the groove hole 511 in the abrasive body 51. The water jet nozzle may spray high-pressure water to form the groove hole 511 in the abrasive body 51. For example, the water jet nozzle may spray a water jet. The punching machine 7 may be disposed perpendicularly to the first surface 51a or a lateral surface of the abrasive article 133. The present disclosure, however, is not limited thereto, and a position and angle of the punching machine 7 may be changed in accordance with a position and shape of the groove hole 511. For example, the punching machine 7 may be positioned on a top surface of the abrasive article 133. The punching machine 7 may be disposed obliquely to an outer surface of the abrasive article 133. One punching machine 7 may form one groove hole 511. The present disclosure, however, is not limited thereto. The punching machine 7 may be provided in plural. As shown in FIG. 17, the plurality of punching machines 7 may be linearly disposed to simultaneously form a plurality of groove holes 511. As shown in FIG. 18, the plurality of punching machines 7 may be multi-linearly and parallel disposed to simultaneously form a plurality of groove holes 511.

Referring to FIG. 19, the abrasive article 133 may have an outer surface on which the groove hole 511 will be formed, and the mask 9 may be disposed on the outer surface of the abrasive article 133. For example, the mask 9 may be disposed on and parallel to the first surface 51a. The punching machine 7 may place the mask 9 on the first surface 51a before the groove hole 511 is formed. The mask 9 may provide a punching hole 9h. The mask 9 may form the groove hole 511 at an exact position without damage to other portions of the abrasive body 51.

Referring to FIG. 20, the punching machine 7 may be linearly disposed on and perpendicular to the first surface 51a. The present disclosure, however, is not limited thereto, and a plurality of punching machines 7 may be linearly disposed on and perpendicularly to the first surface 51a. The punching machine 7 linearly disposed may continuously produce the punching beam 7B. The punching machine 7 may form the groove hole 511 by using the punching beam 7B that passes through the punching hole 9h.

According to a grinding wheel, a back-grinding apparatus including the same, and an abrasive article manufacturing method in accordance with one or more embodiments of the present disclosure, a grinding particle with reduced substrate cutting ability may be easily detached to increase substrate cutting ability of an abrasive article. The degree of detachment of the grinding particle may be consistently maintained by a groove hole formed in an abrasive body. For example, when there is a reduction in cutting ability due to partial abrasion of the grinding particle exposed on a bottom surface of the abrasive body, it may be required that the grinding particle be detached from the abrasive body. When the groove hole is formed in the abrasive body, the grinding particle may be easily detached from the abrasive body. For example, when a portion of the grinding particle is inserted into the groove hole, the grinding particle may be easily detached from the abrasive body.

According to a grinding wheel, a back-grinding apparatus including the same, and an abrasive article manufacturing method in accordance with one or more embodiments of the present disclosure, a density and shape of groove holes may be adjusted to control the degree of grinding of an abrasive article. For example, an over-grinding and durability drop of the abrasive article may be improved by changing a density and shape of groove holes. A water jet or a laser beam may be used to form a groove hole having a zigzag shape, a conical shape, a rectangular hexahedral shape, or any other suitable shapes.

According to a grinding wheel, a back-grinding apparatus including the same, and an abrasive article manufacturing method in accordance with one or more embodiments of the present disclosure, a plurality of groove holes may be simultaneously formed. A plurality of punching machines may be used to form the plurality of groove holes. When a mask is used, the groove hole may be formed without damage to an abrasive body. The mask may be employed to accurately form the groove hole. In a case where a linear or planar punching machine is utilized, when the mask is placed on an outer surface of the abrasive body, a time required for placing the punching machine may be decreased to reduce an overall time required for forming the groove hole.

According to a grinding wheel, a back-grinding apparatus including the same, and an abrasive article manufacturing method of the present disclosure, a groove hole may be used to easily detach grinding particles.

According to a grinding wheel, a back-grinding apparatus including the same, and an abrasive article manufacturing method of the present disclosure, it may be possible to adjust the number of grinding particles and a density and shape of groove holes.

According to a grinding wheel, a back-grinding apparatus including the same, and an abrasive article manufacturing method of the present disclosure, a plurality of groove holes may be formed at the same time.

According to a grinding wheel, a back-grinding apparatus including the same, and an abrasive article manufacturing method of the present disclosure, a mask may be used to form a groove hole.

Effects of the present disclosure are not limited to those mentioned above, other effects which have not been mentioned above will be clearly understood to those skilled in the art from the following description.

Although the present disclosure have been described in connection with one or more embodiments of the present disclosure illustrated in the accompanying drawings, it will be understood to those skilled in the art that various changes and modifications may be made without departing from the technical spirit and essential feature of the present disclosure. It therefore will be understood that the embodiments described above are just illustrative but not limitative in all aspects.

What is claimed is:

1. A grinding wheel comprising:
a wheel body; and
an abrasive article on one surface of the wheel body,
wherein the abrasive article comprises:
an abrasive body comprising a first groove hole that is recessed on a lateral surface of the abrasive article in a first direction; and
a plurality of grinding particles in the abrasive body, and
wherein a length of the first groove hole in the first direction is less than a width of the abrasive body in the first direction.

2. The grinding wheel of claim 1, further comprising a second groove hole that is recessed in the lateral surface of the abrasive article in the first direction,
wherein the lateral surface of the abrasive article comprises:
a first surface; and
a second surface spaced apart in the first direction from the first surface,
wherein the first groove hole is formed from the first surface toward the second surface,
wherein the second groove hole is formed from the second surface toward the first surface, and
wherein the first groove hole and the second groove hole are located at a same level of the abrasive body.

3. The grinding wheel of claim 2, wherein a sum of the length of the first groove hole and a length of the second groove hole is less than the width of the abrasive article, and
wherein the length of the first groove hole is the same as the length of the second groove hole.

4. The grinding wheel of claim 2, further comprising:
a plurality of first groove holes comprising a 1-1^{st} groove hole and a 1-2^{nd} groove hole adjacent to the 1-1^{st} groove hole; and
and a plurality of second groove holes comprising a 2-1^{st} groove hole and a 2-2^{nd} groove hole adjacent to the second groove hole,
wherein the 1-2^{nd} groove hole and the 2-2^{nd} groove hole are located at a same level of the abrasive body,
wherein the length of the 1-1^{st} groove hole is less than the length of the 2-1^{st} groove hole, and
wherein a length of the 1-2^{nd} groove hole is greater than a length of the 2-2^{nd} groove hole.

5. The grinding wheel of claim 1,
wherein the lateral surface of the abrasive article comprises:
a first surface; and
a second surface spaced apart in the first direction from the first surface,
wherein the first groove hole is formed from the first surface toward the second surface,
wherein the first groove hole comprises a plurality of 1-1^{st} groove holes located at a same level of the abrasive body, and
wherein the abrasive body further comprises a third groove hole between the plurality of 1-1^{st} groove holes and recessed in a second direction perpendicular to the first direction.

6. The grinding wheel of claim 5, wherein a length of the third groove hole in the second direction is less than a height of the abrasive article.

7. The grinding wheel of claim 1,
wherein the first groove hole comprises:
a groove body connected to the lateral surface of the abrasive article; and
a groove head connected to an end of the groove body, and
wherein the groove head has one of a hemispherical shape and a conical shape.

8. The grinding wheel of claim 1,
wherein the first groove hole comprises:
a groove body connected to the lateral surface of the abrasive article; and
a groove head connected to an end of the groove body, and
wherein the groove body has one of a conical shape, a cylindrical shape, and a square pillar shape.

9. A back-grinding apparatus comprising:
a spindle assembly that is rotatable and is vertically movable in a vertical direction; and
a substrate support below the spindle assembly,
wherein the spindle assembly comprises:
a grinding wheel; and
a driving unit configured to drive the grinding wheel to move toward the substrate support and away from the substrate support,
wherein the grinding wheel comprises:
a wheel body; and
an abrasive article on a bottom surface of the wheel body,
wherein the abrasive article comprises:
an abrasive body comprising a first groove hole recessed toward the abrasive article from a lateral surface of the abrasive body; and
a plurality of grinding particles in the abrasive body, and
wherein a length of the first groove hole is less than a width of the abrasive article.

10. The back-grinding apparatus of claim 9, wherein the first groove hole extends in a horizontal direction.

11. The back-grinding apparatus of claim 9, further comprising a second groove hole recessed toward the abrasive article from the lateral surface of the abrasive body,
wherein the lateral surface of the abrasive article comprises:
a first surface; and
a second surface spaced apart in a first direction from the first surface, wherein the first groove hole is directed from the first surface toward the second surface, and
wherein the second groove hole is directed from the second surface toward the first surface.

12. The back-grinding apparatus of claim 11, wherein the first groove hole and the second groove hole are located at different levels of the abrasive body.

13. The back-grinding apparatus of claim 12, wherein a sum of the length of the first groove hole and a length of the second groove hole is greater than the width of the abrasive article.

14. The back-grinding apparatus of claim 9, further comprising a plurality of abrasive articles including the abrasive article,
wherein the plurality of abrasive articles are spaced apart from each other in a circumferential direction on the bottom surface of the wheel body.

15. The back-grinding apparatus of claim 11, wherein the first groove hole extends in a zigzag direction toward the second surface.

16. A method of manufacturing an abrasive article, the method comprising:
placing an abrasive body on a lateral surface of a punching machine; and
forming a groove hole in the abrasive body using the punching machine to form the groove hole on a first surface of the abrasive body,
wherein the punching machine comprises one of a water jet nozzle and a laser generator, and the punching machine is configured to produce a punching beam,
wherein the groove hole extends from the first surface toward a second surface of the abrasive body,
wherein the second surface stands opposite to the first surface, and
wherein a length of the groove hole is less than a width of the abrasive body.

17. The method of claim 16,
wherein the punching machine is provided in plural, and
wherein the forming the groove hole on the first surface further comprises using the plurality of punching machines to simultaneously form a plurality of groove holes.

18. The method of claim 16, wherein the forming the groove hole in the abrasive body further comprises, before forming the groove hole on the first surface, placing a mask on the first surface, wherein the mask comprises a punching hole.

19. The method of claim 18, wherein the punching machine is linearly disposed on and perpendicular to the first surface, and
wherein the forming the groove hole on the first surface further comprises causing the punching beam to pass through the punching hole and form the groove hole.

20. The method of claim 16,
wherein the groove hole comprises:
a groove body connected to the lateral surface of the abrasive body; and
a groove head connected to an end of the groove body,
wherein the groove body has one of a cylindrical shape, a square pillar shape, and a conical shape, and
wherein the groove head has one of a hemispherical shape and a conical shape.

21. A back-grinding apparatus comprising:
a substrate support; and
a spindle assembly that is rotatable and is vertically movable in a vertical direction, the spindle assembly comprising:
a grinding wheel comprising a wheel body and an abrasive article disposed on a bottom surface of the wheel body; and
a driving unit configured to drive the grinding wheel to move toward the substrate support and away from the substrate support,
wherein the abrasive article comprises:
an abrasive body comprising a first surface and a second surface spaced apart in a first direction from the first surface,
a plurality of first groove holes formed from the first surface toward the second surface, the plurality of first groove holes comprising a 1-1^{st} groove hole and a 1-2^{nd} groove hole adjacent to the 1-1^{st} groove hole; and
a plurality of second groove holes formed from the second surface toward the first surface, the plurality of second groove holes comprising a 2-1^{st} groove hole and a 2-2^{nd} groove hole adjacent to the 2-1^{st} groove hole; and
a plurality of grinding particles in the abrasive body, and
wherein the 1-1^{st} groove hole and the 2-1^{st} groove hole are located at a first level of the abrasive body,
wherein the 1-2^{nd} groove hole and the 2-2^{nd} groove hole are located at a second level of the abrasive body,
wherein a sum of a length of the 1-1^{st} groove hole and a length of the 2-1^{st} groove hole is less than a width of the abrasive body in the first direction, and
wherein a sum of a length of the 1-2^{nd} groove hole and a length of the 2-2^{nd} groove hole is less than the width of the abrasive body in the first direction.
